(19) United States
(12) Patent Application Publication
(10) Pub. No.: US 2026/0370094 A1
(43) Pub. Date: Nov. 19, 2026

(54) ELECTRIC DRIVE UNIT HAVING AN INTEGRATED FLUID FILTER HOUSING

(71) Applicant: BorgWarner Inc., Auburn Hills, MI (US)

(72) Inventors: Christopher Anthony Chirco, Romeo, MI (US); Aniruddha Chavan, Rochester Hills, MI (US)

(21) Appl. No.: 19/667,860

(22) Filed: May 5, 2026

Related U.S. Application Data
(60) Provisional application No. 63/882,518, filed on Sep. 16, 2025.
(60) Provisional application No. 63/806,435, filed on May 15, 2025.

(51) Int. Cl. H02K 9/26; H02K 5/20; H02K 7/116; H02K 9/19

(52) U.S. Cl. CPC H02K 9/26; H02K 5/203; H02K 7/116; H02K 9/19

(57) ABSTRACT

An electric drive unit includes a housing assembly including a main housing body and a second end cover coupled to the main housing body. The main housing body extends along a first axis and defines a housing interior and a fluid sump in fluid communication with the housing interior. An electric machine, a differential assembly, and a reduction gearset are disposed in the housing interior. A fluid pump is coupled to the main housing body and is configured to direct fluid from the fluid sump to the housing interior. An integrated fluid filter housing is disposed in the fluid sump and is configured to receive a filter for filtering contaminants as the fluid travels from the fluid sump to the fluid pump.

### CROSS-REFERENCE TO RELATED APPLICATIONS

The present application claims priority to and all the benefits of U.S. Provisional Patent Application Nos. 63/806,435 filed on May 15, 2025, and 63/882,518 filed Sep. 16, 2025, which are hereby expressly incorporated herein by reference in their entirety.

### BACKGROUND OF THE INVENTION

### Field of the Invention

The present disclosure relates generally to an electric drive unit having an integrated fluid filter housing.

### Description of Related Art

Electric drive units often package rotating components, such as an electric machine, a reduction gearset, and a differential assembly, within a housing interior of a housing assembly. The housing assembly of such electric drive units often has fluid pathways for facilitating recirculation of cooling and/or lubricating fluid through the housing interior. During operation, contaminants such as wear debris may be introduced into the cooling and/or lubricating fluid. If not removed, these contaminants may circulate through the housing interior and degrade the performance and longevity of the rotating components, fluid pumps, bearings, and other internal componentry. Filtering the fluid therefore presents a persistent design consideration, but integrating a filter within a compact electric drive unit envelope raises additional challenges, including accommodating the filter within the limited packaging envelope provided by the vehicle, preserving service access for routine inspection or replacement, and maintaining reliable fluid communication between the filter and the remaining fluid-handling componentry. Accordingly, there remains a need for an improved electric drive unit having an integrated fluid filter housing.

### SUMMARY AND ADVANTAGES

The present disclosure is generally directed to an electric drive unit including a housing assembly. The housing assembly includes a main housing body extending along a first axis between a first end and a second end spaced from the first end in a first direction along the first axis. The main housing body defines a housing interior about the first axis and defines a fluid sump in fluid communication with the housing interior. The housing assembly further includes a second end cover coupled to the second end of the main housing body to delimit the housing interior and the fluid sump in the first direction. The electric drive unit also includes an electric machine disposed in the housing interior, a differential assembly disposed in the housing interior, and a reduction gearset disposed in the housing interior and coupled to the electric machine and the differential assembly for transmitting torque between the electric machine and the differential assembly. The electric drive unit further includes a fluid pump coupled to the main housing body and configured to direct fluid from the fluid sump to the housing interior. The fluid pump defines a pump inlet in fluid communication with the fluid sump and a pump outlet in fluid communication with the housing interior. The electric drive unit further includes an integrated fluid filter housing disposed in the fluid sump and configured to receive a filter for filtering contaminants as the fluid travels from the fluid sump to the pump inlet.

Advantageously, by integrating the fluid filter housing within the fluid sump, the integrated fluid filter housing is accommodated within space that would otherwise be unused within the housing assembly such that contaminants are filtered from the fluid recirculated through the housing interior without appreciably increasing the overall envelope of the electric drive unit.

### BRIEF DESCRIPTION OF THE DRAWINGS

Other advantages of the present disclosure will be readily appreciated, as the same becomes better understood by reference to the following detailed description when considered in connection with the accompanying drawings.

FIG. 1 is a perspective view of the electric drive unit according to the present disclosure.

FIG. 2A is an exploded view of the electric drive unit of FIG. 1 from a first perspective.

FIG. 2B is another exploded view of the electric drive unit of FIG. 1 from a second perspective.

FIG. 3 is a side view of the electric drive unit.

FIG. 4 is a cross-sectional representation of the electric drive unit taken through line 4-4 of FIG. 3.

FIG. 5 is a detail view of FIG. 4 illustrating an integrated fluid filter housing disposed in a fluid sump of the electric drive unit.

FIG. 6 is a partial perspective cross-sectional representation of the electric drive unit illustrating the integrated fluid filter housing disposed in the fluid sump of the electric drive unit.

FIG. 7 is a partial cross-sectional representation of the electric drive unit illustrating a path between the integrated fluid filter housing and a fluid pump.

FIG. 8 is a cross-sectional representation taken along line 8-8 of FIG. 4 to reveal the componentry of a differential assembly of the electric drive unit.

FIG. 9 is a cross-sectional representation taken along line 9-9 of FIG. 4 to reveal the componentry of a second planetary gearset of the reduction gearset of the electric drive unit.

FIG. 10 is a cross-sectional representation taken along line 10-10 of FIG. 4 to reveal the componentry of a first planetary gearset of the reduction gearset of the electric drive unit.

FIG. 11 is a cross-sectional representation taken along line 11-11 of FIG. 4 to reveal the componentry of an electric machine of the electric drive unit.

FIG. 12 is a perspective view of the electric drive unit illustrating a feeding path and a main supply channel in phantom.

### DETAILED DESCRIPTION OF THE INVENTION

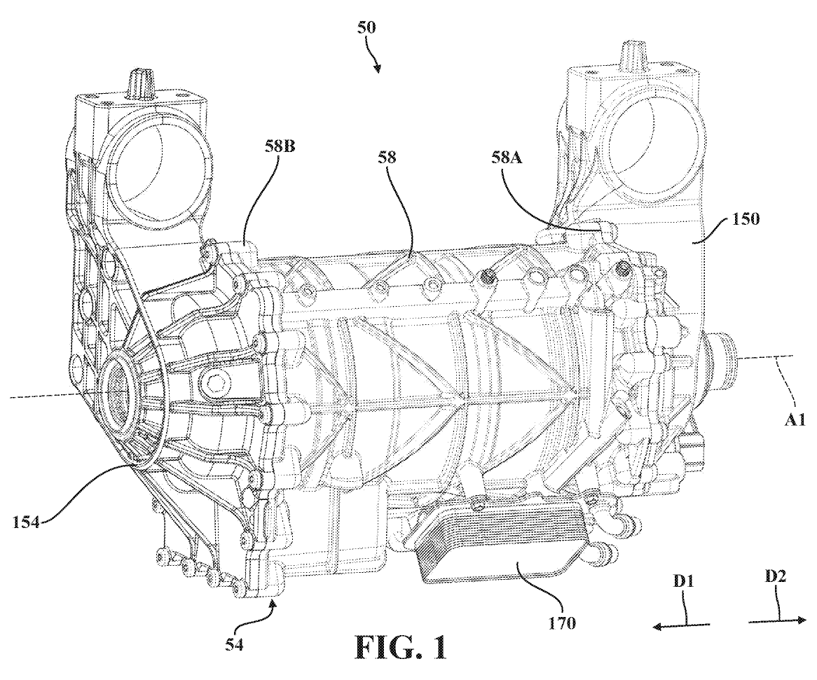

Referring to the drawings, wherein like reference numerals are used to identify like or identical components in the various views, FIG. 1‑12 illustrate an electric drive unit 50 according to the present disclosure. The electric drive unit 50 according to the present disclosure is generally configured for use in an electrified vehicle for providing propulsion torque and/or for receiving regenerative braking torque. While the electric drive unit 50 according to the present disclosure is described in the context of automotive applications, other vehicle applications employing the electric drive unit 50 are also contemplated including, but not limited to, heavy duty trucks, agricultural vehicles, construction vehicles, and recreational vehicles.

Referring to FIG. 1, the electric drive unit 50 includes a housing assembly 54. The housing assembly 54 includes a main housing body 58 extending along a first axis A1 between a first end 58A and a second end 58B spaced from the first end 58A in a first direction D1 along the first axis A1. The main housing body 58 defines a housing interior 62 about the first axis A1 within which the internal componentry of the electric drive unit 50 is disposed. In the illustrated configuration, the main housing body 58 includes a divider wall 66 that subdivides the housing interior 62 into a first chamber 70 and a second chamber 74 extending along the first axis A1. The first chamber 70 is delimited by the divider wall 66 in the first direction D1, and the second chamber 74 is delimited by the divider wall 66 in a second direction D2 opposite the first direction D1. However, other configurations of the housing interior 62 are contemplated, including configurations in which the divider wall 66 is omitted. The electric drive unit 50 further includes various components which rotate in the housing interior 62 including an electric machine 78, a differential assembly 82, and a reduction gearset 86. The reduction gearset 86 is coupled to the electric machine 78 and the differential assembly 82 for transmitting torque between the electric machine 78 and the differential assembly 82. In the illustrated configuration, the electric machine 78 is disposed in the first chamber 70, the differential assembly 82 is disposed in the second chamber 74, and the reduction gearset 86 is disposed in the second chamber 74. Other arrangements are contemplated. Exemplary configurations of the electric machine 78, the differential assembly 82, and the reduction gearset 86 are shown throughout the FIGS. and described in further detail below.

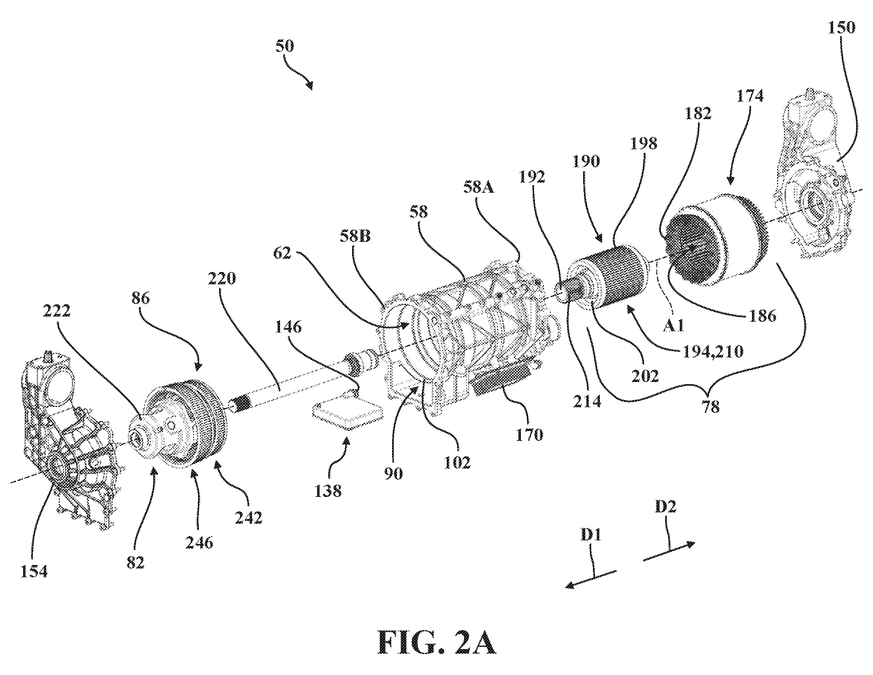

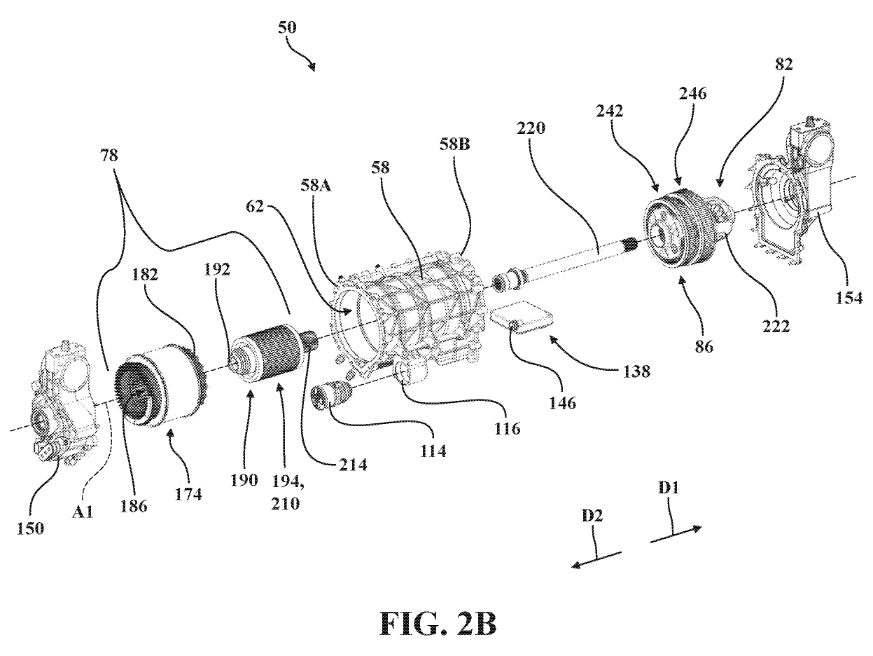

As best shown in FIGS. 2A and 4-10, the main housing body 58 further defines a fluid sump 90 in fluid communication with the housing interior 62. The fluid sump 90 generally serves as a reservoir, also commonly referred to as a basin, for collecting fluid from the housing interior 62 for recirculation through the housing interior 62 (e.g. via a fluid pump 114, as described in further detail below). The fluid may be any cooling and/or lubrication fluid suitable for the application, such as oil. In the illustrated configuration, the fluid sump 90 is spaced radially outward relative to the first axis A1 from the first chamber 70 and the second chamber 74. In the illustrated configuration, the main housing body 58 also defines a first drain path 94 extending between the first chamber 70 and the fluid sump 90 to arrange the first chamber 70 in fluid communication with the fluid sump 90 for returning the fluid from the first chamber 70 to the fluid sump 90. The main housing body 58 additionally defines a second drain path 98 extending between the second chamber 74 and the fluid sump 90 to arrange the second chamber 74 in fluid communication with the fluid sump 90 for returning the fluid from the second chamber 74 to the fluid sump 90. Accordingly, the fluid from the first chamber 70 and the second chamber 74 is directed to and collected in the fluid sump 90 through the first and second drain paths 94, 98, respectively, for recirculation through the housing interior 62. In this regard, the fluid sump 90 serves as a shared reservoir for collecting the fluid from both the first chamber 70 and the second chamber 74 for recirculation through the housing interior 62.

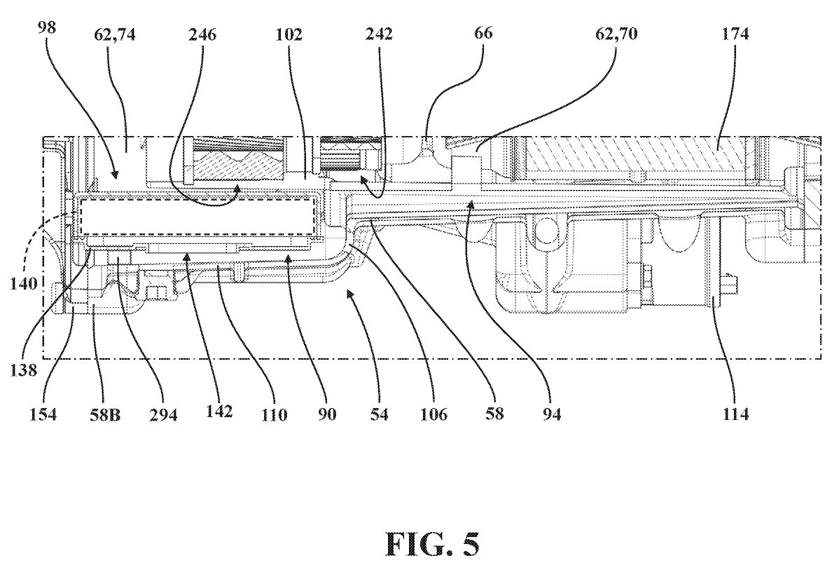

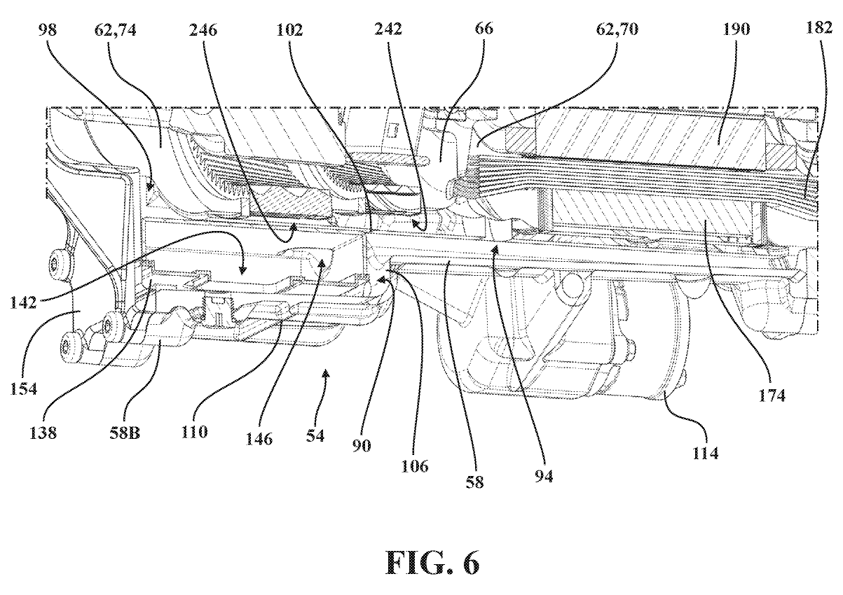

As best shown in FIGS. 5 and 6, in the illustrated configuration, the main housing body 58 may further include an upper sump wall 102 extending axially relative to the first axis A1 to at least partially separate the fluid sump 90 from the first chamber 70 and the second chamber 74. Stated differently, the upper sump wall 102 is configured to at least partially isolate the fluid sump 90 from the first and second chambers 70, 74 of the housing interior 62 while the fluid sump 90 remains in fluid communication with the first and second chambers 70, 74 through the respective first and second drain paths 94, 98. In the illustrated configuration, the first drain path 94 extends through the upper sump wall 102 between the first chamber 70 and the fluid sump 90, and the second drain path 98 extends through the upper sump wall 102 between the second chamber 74 and the fluid sump 90. With continued reference to FIGS. 5 and 6, the main housing body 58 also typically includes a radial extension 106 and a lower sump wall 110 that further delimit the fluid sump 90. In the illustrated configuration, the lower sump wall 110 extends axially relative to the radial extension 106 to define the fluid sump 90 and delimits the fluid sump 90 in a radial direction relative to the first axis A1. However, other configurations for defining the fluid sump 90 are contemplated.

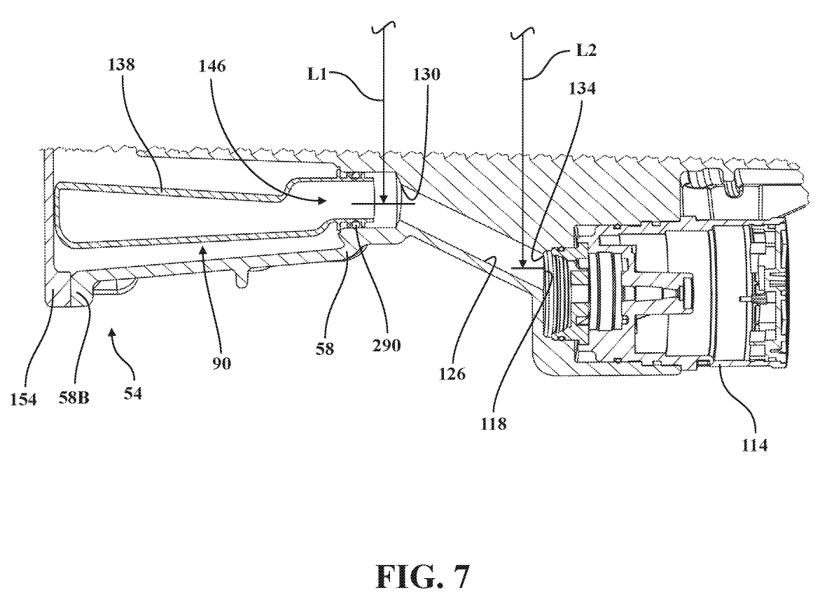

Referring to FIGS. 2B and 4-7, the electric drive unit 50 further includes a fluid pump 114 coupled to the main housing body 58 and configured to direct the fluid from the fluid sump 90 to the housing interior 62. The fluid pump 114 defines a pump inlet 118 in fluid communication with the fluid sump 90 and a pump outlet 122 in fluid communication with the housing interior 62. The fluid pump 114 can be internal or external to the housing assembly 54. In the illustrated configuration, referring to FIG. 2B, the main housing body 58 defines a pump receptacle 116 configured to at least partially receive the fluid pump 114 to couple the fluid pump 114 to the main housing body 58 and arrange the fluid pump 114 in fluid communication with the fluid sump 90 and the housing interior 62. Other configurations of coupling the fluid pump 114 to the main housing body 58 are contemplated without departing from the scope of the present disclosure. As best shown in FIG. 7, to arrange the pump inlet 118 in fluid communication with the fluid sump 90, the main housing body 58 may also define a fluid passage 126 extending between a fluid passage inlet 130 in fluid communication with the fluid sump 90 and a fluid passage outlet 134 in fluid communication with the pump inlet 118 of the fluid pump 114.

As best shown in FIGS. 5 and 6, the electric drive unit 50 further includes an integrated fluid filter housing 138 disposed in the fluid sump 90. As used herein, the modifier “integrated” refers to the fluid filter housing 138 being integrated into the fluid sump 90 such that the fluid filter housing 138 is disposed internal to the fluid sump 90 and not disposed outside of the fluid sump 90. The integrated fluid filter housing 138 is configured to receive a filter 140 (illustrated schematically in FIG. 5) for filtering contaminants as the fluid travels from the fluid sump 90 to the pump inlet 118 of the fluid pump 114. Advantageously, by integrating the fluid filter housing 138 within the fluid sump 90, the integrated fluid filter housing 138 is accommodated within space that would otherwise be unused within the housing assembly 54 such that contaminants are filtered from the fluid recirculated through the housing interior 62 without appreciably increasing the overall envelope of the electric drive unit 50.

As best shown in FIGS. 5-7, the integrated fluid filter housing 138 defines a filter housing inlet 142 in fluid communication with the fluid sump 90 and a filter housing outlet 146 in fluid communication with the fluid passage inlet 130 of the fluid passage 126. Accordingly, in the illustrated configuration, in response to operation of the fluid pump 114, the fluid flows from the fluid sump 90 into the filter housing inlet 142, from the filter housing inlet 142 through the filter 140 disposed in the integrated fluid filter housing 138 to the filter housing outlet 146, from the filter housing outlet 146 to the fluid passage inlet 130, and through the fluid passage 126 to the fluid passage outlet 134 to the fluid pump 114 for recirculation to the housing interior 62. While the illustrated configuration of the integrated fluid filter housing 138 is generally rectangular and occupies a majority of the fluid sump 90, other configurations of the integrated fluid filter housing 138 are contemplated without departing from the scope of the present disclosure.

As best shown in FIG. 7, to inhibit the fluid from bypassing the filter 140 as the fluid travels from the fluid sump 90 to the pump inlet 118, the electric drive unit 50 may further include a seal 290 disposed between the filter housing outlet 146 and the fluid passage inlet 130. The seal 290 inhibits the fluid from flowing directly from the fluid sump 90 to the fluid passage inlet 130. Stated differently, the seal 290 arranges the filter housing outlet 146 in sealed fluid communication with the fluid passage inlet 130 such that the fluid traveling from the fluid sump 90 to the pump inlet 118 passes through the filter 140 for removal of contaminants before reaching the fluid pump 114. In the illustrated configuration, the seal 290 is an O-ring disposed on an outer circumference of a projection of the integrated fluid filter housing 138 that defines the filter housing outlet 146; however, other configurations of the seal 290 are contemplated, and other configurations for inhibiting the fluid from bypassing the filter 140 are contemplated.

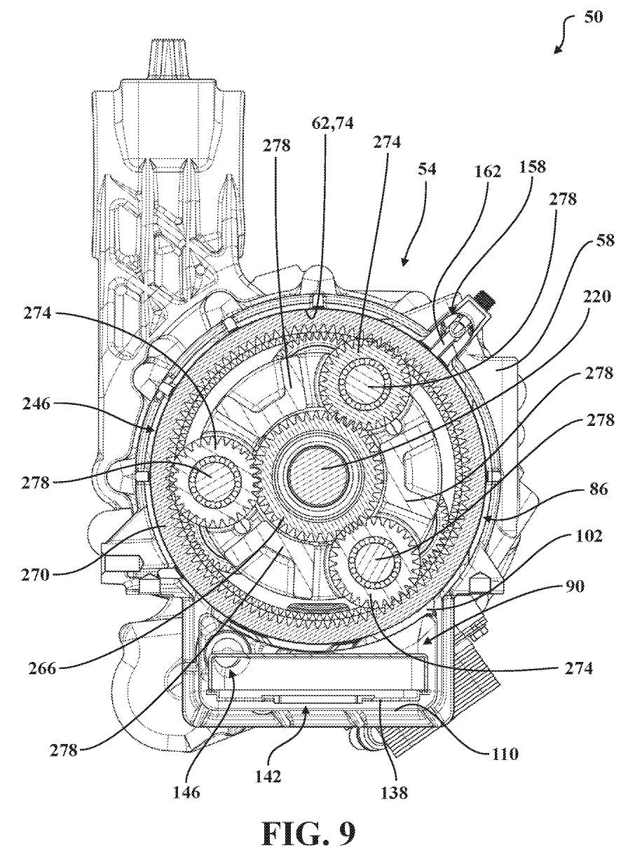

As best shown in FIGS. 5 and 9, in the illustrated configuration, the integrated fluid filter housing 138 includes a foot 294 (or multiple feet 294) arranged to abut the lower sump wall 110 to inhibit translation of the integrated fluid filter housing 138 radially relative to the first axis A1. In the illustrated configuration, the feet 294 extend from the integrated fluid filter housing 138 toward the lower sump wall 110 and abut the lower sump wall 110 to locate the integrated fluid filter housing 138 within the fluid sump 90 in the radial direction relative to the first axis A1. In this way, the feet 294 support the integrated fluid filter housing 138 against the lower sump wall 110 and retain the integrated fluid filter housing 138 in a desired radial position within the fluid sump 90. Other configurations for retaining the integrated fluid filter housing 138 within the fluid sump 90 are contemplated.

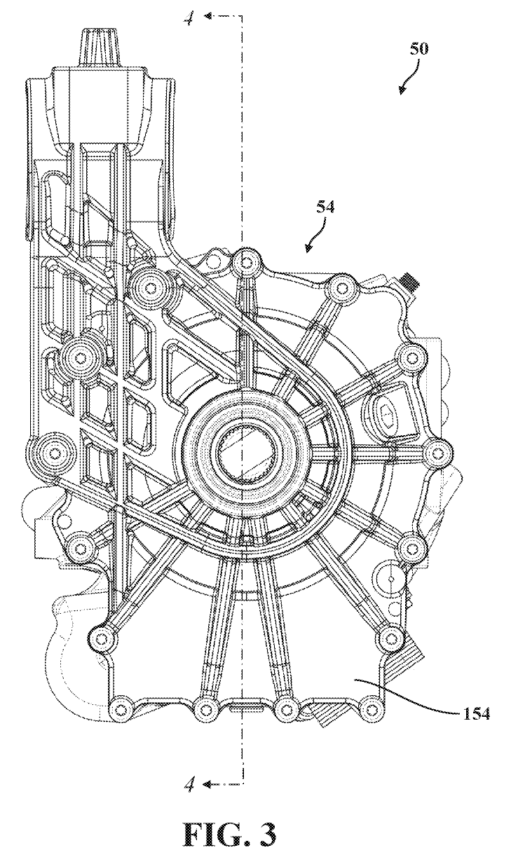

As shown throughout FIGS. 1-7, the housing assembly 54 further includes a second end cover 154 coupled to the second end 58B of the main housing body 58 to delimit the housing interior 62 and the fluid sump 90 in the first direction D1. In the illustrated configuration, as best shown in FIGS. 5-7, the second end cover 154 is arranged to abut the integrated fluid filter housing 138. In this way, the second end cover 154 additionally serves to axially retain the integrated fluid filter housing 138 within the fluid sump 90 and maintain sealed fluid communication between the filter housing outlet 146 and the fluid passage inlet 130 by axially retaining the filter housing outlet 146 in the fluid passage inlet 130. In the illustrated configuration, the second end cover 154 is formed as a separate component that is removably coupled to the second end 58B of the main housing body 58 so that the integrated fluid filter housing 138 disposed in the fluid sump 90 is accessible from the second end 58B for service, inspection, or replacement of the filter 140. However, other configurations where the second end cover 154 is formed integrally or is otherwise permanently coupled with the second end 58B of the main housing body 58 are contemplated. In such configurations, alternative access features may be incorporated in the main housing body 58 to provide access to the integrated fluid filter housing 138. With continued reference to FIGS. 1-7, the housing assembly 54 may further include a first end cover 150 coupled to the first end 58A of the main housing body 58 to delimit the housing interior 62 in the second direction D2. In the illustrated configuration, the first end cover 150 is formed as a separate component that is removably coupled to the first end 58A of the main housing body 58; however, other configurations where the first end cover 150 is formed integrally or is otherwise permanently coupled with the first end 58A of the main housing body 58 are contemplated.

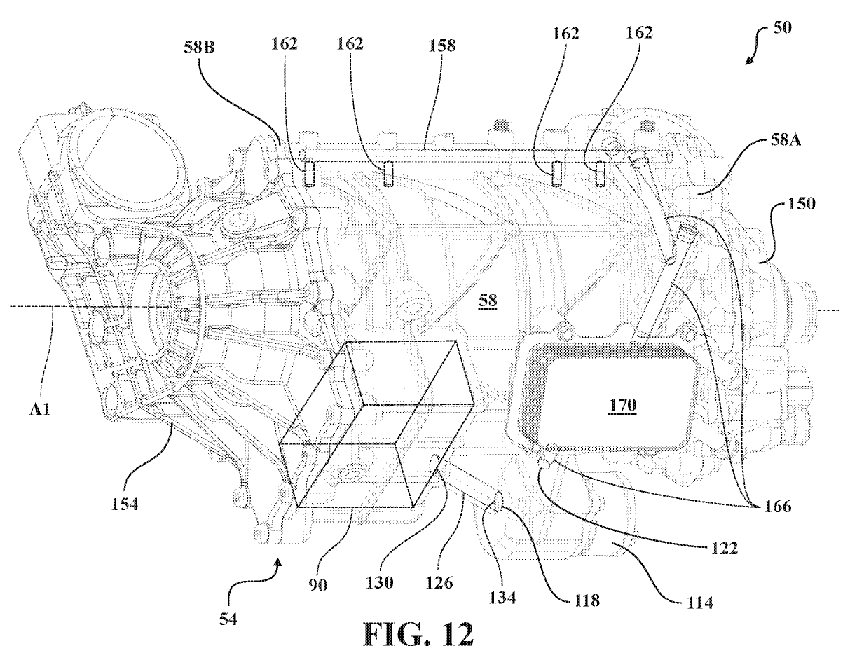

As best shown in FIG. 12, to recirculate the fluid from the fluid sump 90 and fluid pump 114 back to the housing interior 62, the main housing body 58 may further define a main supply channel 158 and a plurality of distribution channels 162. In the illustrated configuration, the main supply channel 158 is spaced radially from the first axis A1 and extends parallel to the first axis A1. As best shown in FIG. 12, in the illustrated configuration, the main supply channel 158 is arranged radially outward from the housing interior 62. Here, the plurality of distribution channels 162 extend between the main supply channel 158 and at least one of the first and second chambers 70, 74 to arrange the main supply channel 158 in fluid communication with at least one of the first chamber 70 and the second chamber 74 for directing the fluid from the main supply channel 158 into the at least one of the first chamber 70 and the second chamber 74. With continued reference to FIG. 12, in the illustrated configuration, the main housing body 58 further defines a fluid feeding path 166 in fluid communication with the pump outlet 122 and the main supply channel 158 for directing the fluid from the pump outlet 122 to the main supply channel 158. Thus, cumulatively, the fluid feeding path 166 arranges the pump outlet 122 in fluid communication with the main supply channel 158, and the plurality of distribution channels 162 arrange the main supply channel 158 in fluid communication with at least one of the first chamber 70 and the second chamber 74 to recirculate the fluid from the fluid sump 90 to the housing interior 62. In some examples, the electric drive unit 50 further includes a heat exchanger 170 disposed in fluid communication along the fluid feeding path 166 so that the fluid driven from the fluid pump 114 can be conditioned (i.e., either cooled or heated) before being redistributed into the housing interior 62 through the main supply channel 158 and the distribution channels 162. Other configurations for recirculating the fluid from the fluid sump 90 and fluid pump 114 back to the housing interior 62 are contemplated.

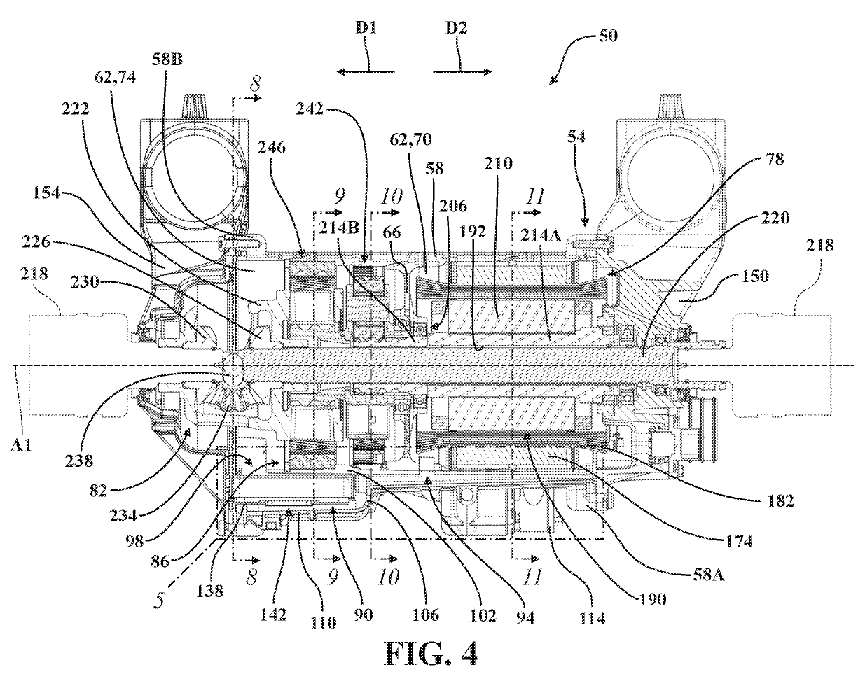

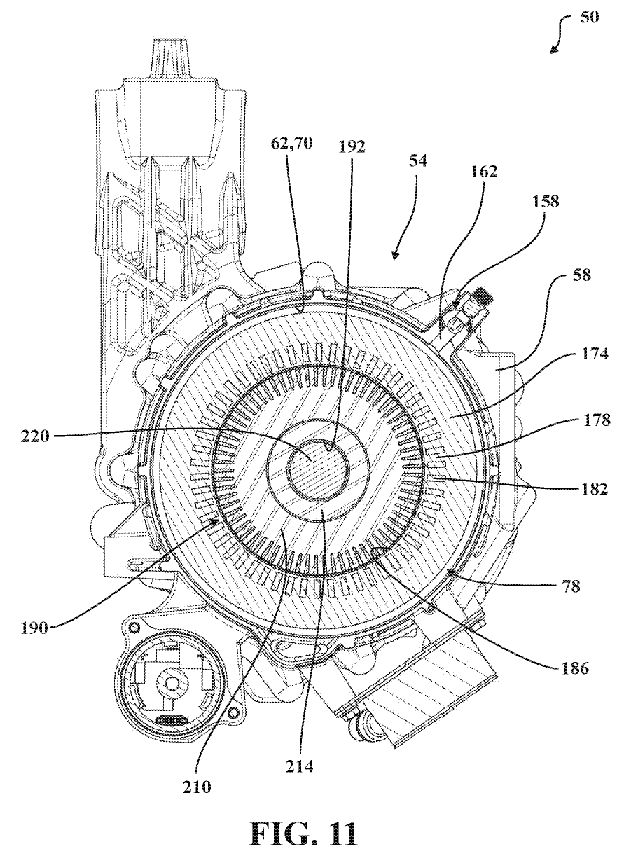

As described above, the electric drive unit 50 includes the electric machine 78. The electric machine 78 is generally configured to generate torque for transfer through the reduction gearset 86 and the differential assembly 82 to propel the vehicle, and may further be configured to receive torque such that the electric machine 78 operates as a generator to regeneratively brake the vehicle. The configuration of the electric machine 78 is not limited for the purposes of this disclosure. Exemplary configurations of the electric machine 78 include permanent magnet synchronous motors, wound-field synchronous motors, switched reluctance motors, synchronous reluctance motors, brushless DC motors, and asynchronous induction motors. As best shown in FIGS. 4 and 11, which represent an asynchronous induction motor configuration, the electric machine 78 includes a stator 174 coupled to the main housing body 58 and disposed annularly about the first axis A1. While the configuration of the stator 174 is not necessarily limited for the purposes of this disclosure, in the illustrated configuration, the stator 174 includes a stator body 176 comprising a plurality of metallic sheets that are laminated together. The stator body 176 may define stator teeth 178 extending radially inward toward the first axis A1. Stator windings 182 may be disposed between the stator teeth 178. In one implementation, the stator windings 182 can be hairpin stator windings; however, other types of stator windings 182 are contemplated. The stator windings 182 can be coupled to a vehicle battery via an inverter and other power electronics that selectively invert the direct current (DC) electrical power stored in the vehicle battery into alternating current (AC) electrical current, and supply the AC electrical current to the stator windings 182 to energize the stator windings 182.

In the illustrated configuration, the stator 174 defines a stator bore 186, and the electric machine 78 further includes a rotor 190 disposed in the stator bore 186 for rotation relative to the stator 174 about the first axis A1 in response to energization of the stator 174 (e.g. in response to energization of the stator windings 182). While the configuration of the rotor 190 is not necessarily limited for the purposes of this disclosure, in the illustrated asynchronous induction motor configuration, the rotor 190 includes a rotor cage 194 having a plurality of metal bars 198 spaced circumferentially about the first axis A1, and a plurality of metallic sheets 202 laminated together and coupled to the plurality of metal bars 198 to cumulatively constitute the rotor 190. Accordingly, in response to energization of the stator windings 182, a magnetic field generated by the stator 174 electromagnetically interacts with the rotor 190 to produce torque on the rotor 190 to rotate the rotor 190 about the first axis A1.

With continued reference to FIG. 4, in the illustrated configuration, the reduction gearset 86 is disposed in the second chamber 74; however, it should be appreciated that in other configurations the reduction gearset 86 may be disposed in the first chamber 70. In configurations where the reduction gearset 86 is disposed in the second chamber 74, the divider wall 66 may define a central void 206 extending along the first axis A1 between the first chamber 70 and the second chamber 74. In these configurations, the rotor 190 may include a rotor body 210 disposed in the stator bore 186 and a rotor shaft 214 extending along the first axis A1. Here, the rotor shaft 214 includes a first rotor shaft portion 214A coupled to the rotor body 210 such that the rotor shaft 214 rotates with the rotor body 210 about the first axis A1 in response to energization of the stator 174, and a second rotor shaft portion 214B extending from the first rotor shaft portion 214A in the first direction D1 through the central void 206 of the divider wall 66. As best shown in FIG. 4, the second rotor shaft portion 214B is coupled to the reduction gearset 86 to transmit torque between the electric machine 78 and the reduction gearset 86. Other configurations of coupling the rotor 190 of the electric machine 78 to the reduction gearset 86 are contemplated.

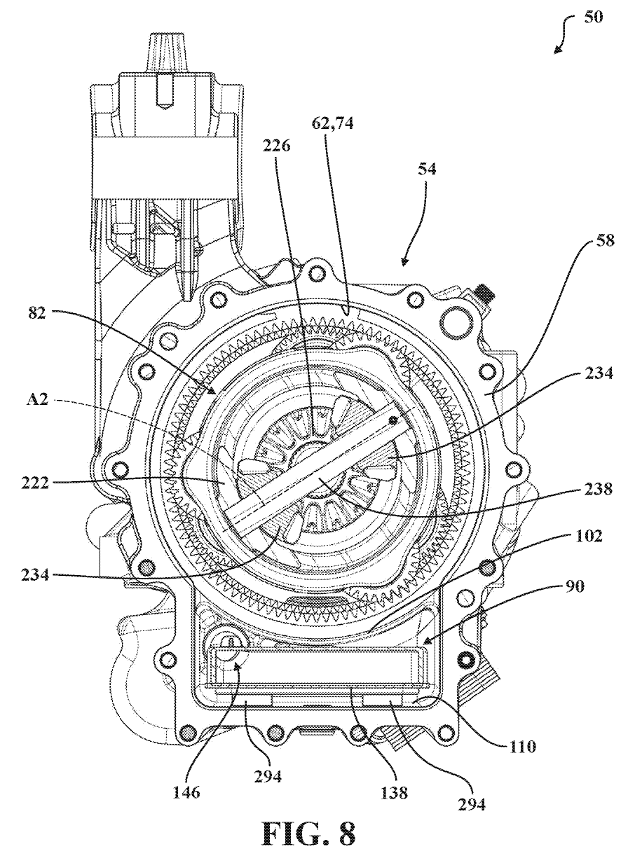

As also described above, the electric drive unit 50 includes the differential assembly 82. The differential assembly 82 is generally configured to receive torque generated by the electric machine 78 (and provided to the differential assembly 82 via the reduction gearset 86) and to transmit that torque to respective half shafts 218 (shown in FIG. 4) while accommodating differential rotation of the half shafts 218 relative to one another. The configuration of the differential assembly 82 is not limited for the purposes of this disclosure. As best shown in FIGS. 4 and 8, in the illustrated configuration, the differential assembly 82 includes a pinion carrier 222 supported for rotation about the first axis A1. The illustrated differential assembly 82 also includes a first side gear 226 disposed in the pinion carrier 222 for rotation relative to the pinion carrier 222 about the first axis A1. The first side gear 226 is configured to be coupled (directly or indirectly through an intermediate component) to one of the half shafts 218. As best shown in FIG. 4, in some embodiments, the electric drive unit 50 further includes a link shaft 220 coupled to the first side gear 226. The link shaft 220 serves as an intermediate component for coupling the first side gear 226 to one of the half shafts 218. In these configurations, the rotor 190 may define a central bore 192 extending along the first axis A1, and the link shaft 220 typically extends from the first side gear 226 in the second direction D2 through the central bore 192 of the rotor 190. Here, the end of the link shaft 220 opposite the first side gear 226 is configured to be coupled to one of the half shafts 218. Other configurations for coupling the first side gear 226 to one of the half shafts 218 are contemplated.

The illustrated differential assembly 82 further includes a second side gear 230 disposed in the pinion carrier 222 opposite the first side gear 226 for rotation relative to the pinion carrier 222 about the first axis A1. The second side gear 230 is configured to be coupled (directly or indirectly through an intermediate component) to the other of the half shafts 218. The illustrated differential assembly 82 further includes a plurality of pinion gears 234 coupled to the pinion carrier 222 for rotation about a second axis A2 transverse to the first axis A1. For example, the plurality of pinion gears 234 may be coupled to the pinion carrier 222 via a pinion shaft 238 coupled to the pinion carrier 222 for rotation with the pinion carrier 222 about the first axis A1. Where included, the pinion shaft 238 extends along the second axis A2 and the plurality of pinion gears 234 are coupled to the pinion shaft 238 for rotation about the second axis A2. Each pinion gear 234 is meshed with the first side gear 226 and the second side gear 230. The plurality of pinion gears 234 permit the first side gear 226 and the second side gear 230 to rotate at different angular speeds relative to one another. Thus, for example, when the vehicle including the electric drive unit 50 turns or one drive wheel experiences a traction difference, the plurality of pinion gears 234 rotate about the second axis A2 to accommodate the relative speed differential between the side gears 226, 230 while maintaining torque transfer to at least one of the side gears 226, 230.

As also described above, the electric drive unit 50 includes the reduction gearset 86 for transmitting torque between the electric machine 78 and the differential assembly 82. The configuration of the reduction gearset 86 is not limited for the purposes of this disclosure. Exemplary configurations of the reduction gearset 86 include planetary gearsets, layshaft gearsets, countershaft gearsets, parallel axis gearsets, compound gearsets, and multi-stage reduction gearsets. Where the reduction gearset 86 includes planetary gearsets, the reduction gearset 86 may include a single-stage planetary gearset or multi-stage planetary gearsets. As best shown in FIGS. 4 and 9-10, in the illustrated configuration, the reduction gearset 86 includes a first planetary gearset 242 and a second planetary gearset 246 arranged in series to constitute a two-stage planetary reduction gearset.

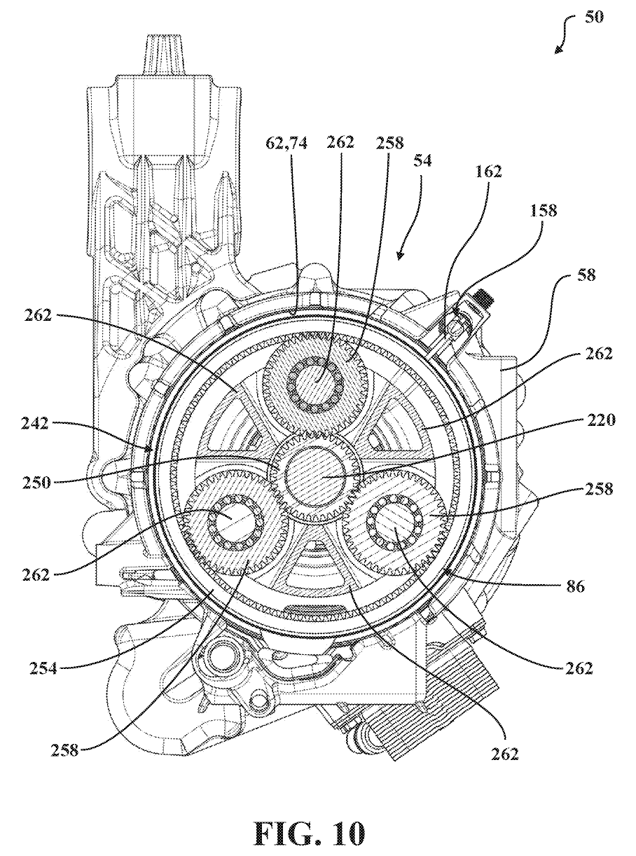

As best shown in FIG. 10, the first planetary gearset 242 includes a first sun gear 250. The first sun gear 250 is coupled to the electric machine 78 to transfer torque between the electric machine 78 and the reduction gearset 86. More specifically, the first sun gear 250 may be coupled to the second rotor shaft portion 214B for rotation with the rotor 190 about the first axis A1. In the illustrated configuration, the first sun gear 250 is integral with the second rotor shaft portion 214B, but configurations where the first sun gear 250 is a separate component coupled to the rotor shaft 214 are contemplated. The first planetary gearset 242 of the illustrated reduction gearset 86 also includes a first ring gear 254 fixed to the main housing body 58. The first ring gear 254 is typically fixed to the main housing body 58 such that the first ring gear 254 is rotationally constrained relative to the main housing body 58. For example, the first ring gear 254 may be welded or otherwise fastened to the main housing body 58. The first planetary gearset 242 of the illustrated reduction gearset 86 further includes a plurality of first planet gears 258 disposed between and meshed with the first sun gear 250 and the first ring gear 254. Accordingly, the plurality of first planet gears 258 are configured to orbit about the first axis A1 in response to rotation of the first sun gear 250. The first planetary gearset 242 of the illustrated reduction gearset 86 additionally includes a first planet carrier 262 coupled to the plurality of first planet gears 258. More specifically, the first planet carrier 262 maintains an angular spacing about the first axis A1 between each planet gear 258 of the plurality of first planet gears 258. Accordingly, the first planet carrier 262 rotates about the first axis A1 as the plurality of first planet gears 258 orbit about the first axis A1. In other words, during operation of the first planetary gearset 242, rotation of the first sun gear 250 at a first input speed causes the first planet gears 258 to orbit about the first axis A1, thereby driving rotation of the first planet carrier 262 about the first axis A1 at a first output speed less than the first input speed. The ratio of the first input speed to the first output speed defines the gear ratio of the first planetary gearset 242 of the illustrated reduction gearset 86.

As best shown in FIG. 9, the second planetary gearset 246 of the illustrated reduction gearset 86 includes a second sun gear 266 coupled to the first planet carrier 262 for rotation with the first planet carrier 262 about the first axis A1. Stated differently, the output of the first planetary gearset 242 (i.e., the first planet carrier 262) is coupled to the input of the second planetary gearset 246 (i.e., the second sun gear 266) such that the first planetary gearset 242 and the second planetary gearset 246 are arranged in series. The second planetary gearset 246 of the illustrated reduction gearset 86 also includes a second ring gear 270 fixed to the main housing body 58. The second ring gear 270 is typically fixed to the main housing body 58 such that the second ring gear 270 is rotationally constrained relative to the main housing body 58. For example, the second ring gear 270 may be welded or otherwise fastened to the main housing body 58. The second planetary gearset 246 of the illustrated reduction gearset 86 further includes a plurality of second planet gears 274 disposed between and meshed with the second sun gear 266 and the second ring gear 270. Accordingly, the plurality of second planet gears 274 are configured to orbit about the first axis A1 in response to rotation of the second sun gear 266. The second planetary gearset 246 of the illustrated reduction gearset 86 additionally includes a second planet carrier 278 coupled to the second planet gears 274 and the differential assembly 82 to transmit torque between the reduction gearset 86 and the differential assembly 82. More specifically, the second planet carrier 278 maintains an angular spacing about the first axis A1 between each planet gear 274 of the plurality of second planet gears 274. Accordingly, the second planet carrier 278 rotates about the first axis A1 as the plurality of second planet gears 274 orbit about the first axis A1. In other words, during operation of the second planetary gearset 246, rotation of the second sun gear 266 at a second input speed causes the second planet gears 274 to orbit about the first axis A1, thereby driving rotation of the second planet carrier 278 about the first axis A1 at a second output speed less than the second input speed. The ratio of the second input speed to the second output speed defines the gear ratio of the second planetary gearset 246 of the illustrated reduction gearset 86. Cumulatively, the product of the gear ratio of the first planetary gearset 242 and the gear ratio of the second planetary gearset 246 defines the overall gear ratio of the reduction gearset 86. The reduction gearset 86 may have a gear ratio of 2:1 or greater, 5:1 or greater, 10:1 or greater, 15:1 or greater, 20:1 or greater, etc.

In the illustrated configuration, to transmit torque between the reduction gearset 86 and the differential assembly 82, the second planet carrier 278 of the second planetary gearset 246 is coupled to the pinion carrier 222 of the differential assembly 82 for rotation with the pinion carrier 222 about the first axis A1. Accordingly, the torque transmission path through the electric drive unit 50 extends from the electric machine 78 to the reduction gearset 86 and to the differential assembly 82. In other words, rotation generated by the rotor 190 is carried by the rotor shaft 214 to the first sun gear 250, transferred through the first planetary gearset 242 to the first planet carrier 262, passed from the first planet carrier 262 to the second sun gear 266, and then transferred through the second planetary gearset 246 to the second planet carrier 278 and ultimately to the pinion carrier 222 of the differential assembly 82. The differential assembly 82 then distributes the torque between the first side gear 226 and the second side gear 230. It should be appreciated that the configurations of the electric machine 78, the reduction gearset 86, and the differential assembly 82 illustrated and described herein are intended to serve as illustrative examples of suitable configurations of the electric machine 78, the reduction gearset 86, and the differential assembly 82 and the resulting torque transmission path therethrough, and that other configurations are contemplated.

Several embodiments have been described in the foregoing description. However, the embodiments described herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular. It will be further appreciated that the terms “include,” “includes,” and “including” have the same meaning as the terms “comprise,” “comprises,” and “comprising.”

What is claimed is:

1. An electric drive unit comprising:
a housing assembly comprising:
a main housing body extending along a first axis between a first end and a second end spaced from said first end in a first direction along said first axis, wherein said main housing body defines a housing interior about said first axis and defines a fluid sump in fluid communication with said housing interior; and
a second end cover coupled to said second end of said main housing body to delimit said housing interior and said fluid sump in said first direction;
an electric machine disposed in said housing interior;
a differential assembly disposed in said housing interior;
a reduction gearset disposed in said housing interior and coupled to said electric machine and said differential assembly for transmitting torque between said electric machine and said differential assembly;
a fluid pump coupled to said main housing body and configured to direct fluid from said fluid sump to said housing interior, wherein said fluid pump defines a pump inlet in fluid communication with said fluid sump and a pump outlet in fluid communication with said housing interior; and
an integrated fluid filter housing disposed in said fluid sump and configured to receive a filter for filtering contaminants as the fluid travels from said fluid sump to said pump inlet.

2. The electric drive unit according to claim 1, wherein said main housing body defines a fluid passage extending between:
a fluid passage inlet in fluid communication with said fluid sump; and
a fluid passage outlet in fluid communication with said pump inlet of said fluid pump.

3. The electric drive unit according to claim 2, wherein said integrated fluid filter housing has a filter housing inlet in fluid communication with said fluid sump and a filter housing outlet in fluid communication with said fluid passage inlet of said fluid passage.

4. The electric drive unit according to claim 3 further comprising a seal disposed between said filter housing outlet and said fluid passage inlet to inhibit the fluid from flowing directly from said fluid sump to said fluid passage inlet.

5. The electric drive unit according to claim 3, wherein said second end cover abuts said integrated fluid filter housing to retain said filter housing outlet in said fluid passage inlet.

6. The electric drive unit according to claim 1, wherein said second end cover is removably coupled to said main housing body so said integrated fluid filter housing disposed in said fluid sump is accessible from said second end.

7. The electric drive unit according to claim 1, wherein said fluid sump is delimited in a radial direction relative to said first axis by a lower sump wall and said integrated fluid filter housing includes a foot arranged to abut said lower sump wall to inhibit translation of said integrated fluid filter housing radially relative to said first axis.

8. The electric drive unit according to claim 1, wherein said main housing body includes a radial extension and a lower sump wall extending axially relative to the radial extension to define said fluid sump.

9. The electric drive unit according to claim 1, wherein said housing assembly further comprises a first end cover coupled to said first end of said main housing body to delimit said housing interior in a second direction opposite said first direction.

10. The electric drive unit according to claim 1, wherein said main housing body includes a divider wall that subdivides said housing interior into a first chamber extending along said first axis and delimited by said divider wall in said first direction, and a second chamber extending along said first axis delimited by said divider wall in a second direction opposite said first direction.

11. The electric drive unit according to claim 10, wherein said electric machine is disposed in said first chamber, said differential assembly is disposed in said second chamber, and said reduction gearset is disposed in said second chamber.

12. The electric drive unit according to claim 10, wherein said main housing body further defines:
a first drain path extending between said first chamber and said fluid sump to return the fluid from said first chamber to said fluid sump; and
a second drain path extending between said second chamber and said fluid sump to return the fluid from said second chamber to said fluid sump.

13. The electric drive unit according to claim 1, wherein said electric machine comprises:
a stator coupled to said main housing body and disposed annularly about said first axis, said stator defining a stator bore; and
a rotor disposed in said stator bore for rotation relative to said stator about said first axis in response to energization of said stator.

14. The electric drive unit according to claim 13, wherein said rotor comprises a rotor body disposed in said stator bore and a rotor shaft extending along said first axis between:
a first rotor shaft portion coupled to said rotor body such that said rotor shaft rotates with said rotor about said first axis in response to energization of said stator; and
a second rotor shaft portion extending from said first rotor shaft portion in said first direction, said second rotor shaft portion coupled to said reduction gearset to transmit torque between said electric machine and said differential assembly.

15. The electric drive unit according to claim 1, wherein said differential assembly comprises:
a pinion carrier supported for rotation about said first axis;
a first side gear disposed in said pinion carrier for rotation relative to said pinion carrier about said first axis;
a second side gear disposed in said pinion carrier opposite said first side gear for rotation relative to said pinion carrier about said first axis; and
a plurality of pinion gears coupled to said pinion carrier for rotation about a second axis transverse to said first axis, each of said plurality of pinion gears meshed with said first side gear and said second side gear to transfer torque from said pinion carrier to said first side gear and said second side gear.

16. The electric drive unit according to claim 15, wherein said electric machine includes a rotor defining a central bore extending along said first axis; and
wherein said electric drive unit further comprises a link shaft coupled to said first side gear and extending from said first side gear in a second direction opposite said first direction along said first axis through said central bore of said rotor.

17. The electric drive unit according to claim 1, wherein said reduction gearset comprises:
a first planetary gearset comprising:
a first sun gear coupled to said electric machine to transmit torque between said reduction gearset and said electric machine;
a first ring gear fixed to said main housing body;
a plurality of first planet gears disposed between and meshed with said first sun gear and said first ring gear such that said plurality of first planet gears orbit about said first axis in response to rotation of said first sun gear; and
a first planet carrier coupled to said plurality of first planet gears such that said first planet carrier rotates about said first axis in response to rotation of said first sun gear; and
a second planetary gearset comprising:
a second sun gear coupled to said first planet carrier for rotation with said first planet carrier about said first axis;
a second ring gear fixed to said main housing body;
a plurality of second planet gears disposed between and meshed with said second sun gear and said second ring gear such that said plurality of second planet gears orbit about said first axis in response to rotation of said second sun gear; and
a second planet carrier coupled to said plurality of second planet gears and said differential assembly to transmit torque between said reduction gearset and said differential assembly.
